(19) United States
(12) Patent Application Publication
(10) Pub. No.: US 2023/0236045 A1
(43) Pub. Date: Jul. 27, 2023

(54) METHOD OF ANALYZING A MONITORING SIGNAL FROM A SENSING SYSTEM TO DETERMINE AN ALARM CONDITION

(71) Applicant: Network Integrity Systems, Inc., Hickory, NC (US)

(72) Inventors: Cary R. Murphy, Hickory, NC (US); Mark K. Bridges, Hickory, NC (US); Daniel M. Goertzen, Winnipeg (CA)

(21) Appl. No.: 17/583,611

(22) Filed: Jan. 25, 2022

(51) Int. Cl. G01D 7/12; G01D 1/18

(52) U.S. Cl. CPC G01D 7/12; G01D 1/18

(57) ABSTRACT

A method is provided for analyzing a monitoring signal from a sensing system to determine an alarm condition, where the monitoring signal is provided as a stream of digital values which are analyzed using a frequency-based or time-based algorithm to generate a plot of elements, applying a delta to each element of the plot of elements to adjust sensitivity thereof to provide a threshold and comparing a plurality of the elements of the stream with the threshold and triggering the alarm condition in the event that the threshold is exceeded; where the algorithm is changed in different time periods in response to ambient conditions of the environment determined for those time periods.

This invention relates to a method of analyzing a monitoring signal from a sensing system where the monitoring signal varies over time to determine an alarm condition.

### BACKGROUND OF THE INVENTION

This application can optionally use the method of frequency analysis disclosed in U.S. Pat. No. 7,634,387 issued Dec. 15, 2009 to the present applicants, the disclosure of which is incorporated herein by reference.

The above system uses optical fibers as the sensing system, but the methods disclosed herein are also applicable to other sensing systems which can be used.

Often in data collection and analysis, for example of the type disclosed above, there arises a need to reject ambient signals in the interest of increasing functional sensitivity to the signals being detected. In the physical layer fiber optic intrusion detection systems described above, a system must detect motion in a fiber representative of an intrusion attempt, while ignoring such signals as air currents and vibrations. Simple threshold detection can otherwise be overwhelmed by the ambient.

Ambient signals are often periodic in nature, partly due to the resonant frequency of the system being monitored, fundamental to both the material and installation. For example, a fiber strung over an air duct will resonate at a repeatable frequency. A fiber in a conduit adjacent to an elevator will also have a unique frequency, while an intrusion into a fiber will often be less periodic. It is useful to desensitize the system from the ambient, while maintaining sensitivity to non-learned conditions.

### SUMMARY OF THE INVENTION

According to a first aspect of the invention there is provided a method of analyzing a monitoring signal from a sensing system where the monitoring signal varies over time to determine an alarm condition,

the sensing system being located in an environment including ambient conditions and operating during a plurality of different time periods;

the method comprising:

providing the monitoring signal as a stream of digital values;

analyzing the stream of digital values using a frequency-based or time-based algorithm to generate a plot of elements obtained from the analysis;

applying a delta additively or multiplicatively to each element of the plot of elements to adjust sensitivity thereof to provide a threshold;

comparing a plurality of the elements of the stream with the threshold and triggering the alarm condition in the event that the threshold is exceeded;

and changing the algorithm in different time periods in response to ambient conditions of the environment determined for those time periods.

In one optional embodiment, the algorithm is changed by changing the delta.

In one optional embodiment, the ambient conditions are determined based on a time of week.

In one optional embodiment, the ambient conditions are determined based on seasonal changes.

In one optional embodiment, the ambient conditions are determined based on Calendar events.

In one optional embodiment, the ambient conditions are determined based on programmable events,

In one optional embodiment, the ambient conditions are determined based on monitoring external conditions including one or more of outdoor temperature, humidity, and wind.

Thus sensors may be used to input data on the ambient conditions. The sensors can include for example: clock, calendar, rain gauge, anemometer, thermometer, seismometer. The data from the sensors can be in real time or can obtained from stored data. In addition equipment located in the environment may be provided with a system so as to communicate the status of the equipment directly to the processor without the necessity for an added sensor. This can apply for example to equipment such as HVAC devices, doors, elevators where there is no sensor added or required because the status of the device can be directly communicated to the processor for use in the algorithm.

In one optional embodiment, the ambient conditions are determined based on HVAC activity.

In one optional embodiment, the algorithm is changed to as to change a sensitivity of the detection algorithm as function of the timing considerations.

In one optional embodiment, the algorithm is changed to as to change a sensitivity of the detection algorithm as a function of magnitude of the event.

In one optional embodiment, the algorithm is changed to as to change a sensitivity of the detection algorithm as a function of a magnitude of the ambient conditions.

In one optional embodiment, the algorithm is changed over a long period of time including many individual periods or windows so as to store incremental values, and so as to select the portions that correspond to certain time windows or periods within the long period. This allows the time windows to be selected and changed. In this way, long term events such as shift changes and working hours can be detected and entered into the algorithm. in some cases the long-term events such as shift hours can change due to vacation, additional working or other reason. That is the required environmental conditions for a known time period, such as a work shift, are known and the processor has information as to when these occur. In the event that an additional similar time period is added or removed for example at a vacation or at an added shift, the conditions known to be required for existing time periods can be added simply in the new time period without the necessity to determine the characteristics of the new time period.

In regard to work shifts therefore, the typical situation is that the conditions required for the work shift are known and the conditions required for the non-working time period are also known and can be readily applied. It is possible that intermediate conditions may apply in some circumstances where for example a partial work force attend. It is possible therefore to have at least one third intermediate set of conditions so that the processor has information as to a full shift, a partial shift and non-working. As these are already known and already established by analysis of the alarm responses, they can be readily applied from available data.

In a yet further situation, the processor can be arranged to look for events which occur at certain situations such as at certain times which act to trigger a false alarm condition. The processor therefore can be arranged to generate data related to those events and the conditions under which they occur so that the processor can be programmed to act on those future events without triggering a false alarm or by reducing sensitivity when the event is expected.

In one optional embodiment, a series of autoconfigurations is performed during each specified time window.

In one optional embodiment, the algorithm is changed to as to change alarm sensitivity such as an ambient rejection threshold.

In one optional embodiment, the frequency algorithm comprises: dividing the sample stream in to equal length pieces each containing a series of the values; using a microprocessor to apply a Fourier Transform (FT) algorithm to transform each piece of the stream into a three-dimensional dataset including frequency domain amplitude, frequency and time and calculating a Frequency Envelope by taking the maxima over the time dimension for a period of time, leaving a two-dimensional frequency domain amplitude vs frequency dataset.

In one optional embodiment, the time-based algorithm comprises: monitoring the magnitude of change of the monitor signal within a specific threshold (dB limit) and period (time interval) before causing an intrusion detection alarm. The characteristics of the time-based algorithm (amplitude and time duration) are dependent on the abrupt physical manipulation of the sensor which results from an intrusion. That is, only if the signal change exceeds the threshold setting within the set time period interval an alarm will be triggered.

Preferably the signal is extracted from an optical fiber in response to the injection into the fiber of a signal from a source and wherein the alarm condition is detection of movement in the fiber indicative of an intrusion event.

According to a second aspect of the invention there is provided a method of analyzing a monitoring signal from a sensing system where the monitoring signal varies over time to determine an alarm condition,

the sensing system being located in an environment including ambient conditions and operating during a plurality of different time periods;

the method comprising:

providing the monitoring signal as a stream of digital values;

analyzing the stream of digital values using a frequency-based or time-based algorithm to generate a plot of elements obtained from the analysis;

comparing a plurality of the elements of the stream with a reference signal and triggering the alarm condition in the event that a difference from the reference is exceeded;

and changing the reference signal in different time periods in response to ambient conditions of the environment determined for those time periods.

According to a third aspect of the invention there is provided a method of analyzing a monitoring signal from a sensing system where the monitoring signal varies over time to determine an alarm condition, the method comprising:

the sensing system being located in an environment including ambient conditions and operating during a plurality of different time periods;

providing the monitoring signal as a stream of digital values;

analyzing the stream of digital values using a time-based algorithm to generate a plot of elements obtained from the analysis;

applying a delta additively or multiplicatively to each element of the plot of elements to adjust sensitivity thereof to provide a threshold;

comparing a plurality of the elements of the stream with the threshold and triggering the alarm condition in the event that the threshold is exceeded;

and changing the time-based algorithm in different time periods in response to ambient conditions of the environment determined for those time periods.

### BRIEF DESCRIPTION OF THE DRAWINGS

FIG. 1 shows schematic operation of the invention wherein environmental sensors provide input to the detection systems in order to compensate for events that are not indicative of alarmable activity.

FIG. 2 shows schematic operation of the invention wherein time values provide input to the detection systems in order to accommodate acceptable changes in the environment.

FIG. 3 is taken from FIG. 1 of the above cited patent and shows a graph obtained from the Frequency based algorithm where a delta is added to the averaged frequency envelope to provide a threshold value to compare with new data in the incoming stream.

FIG. 4 shows the same graph as FIG. 3 modified to use the environmental data according to the present invention.

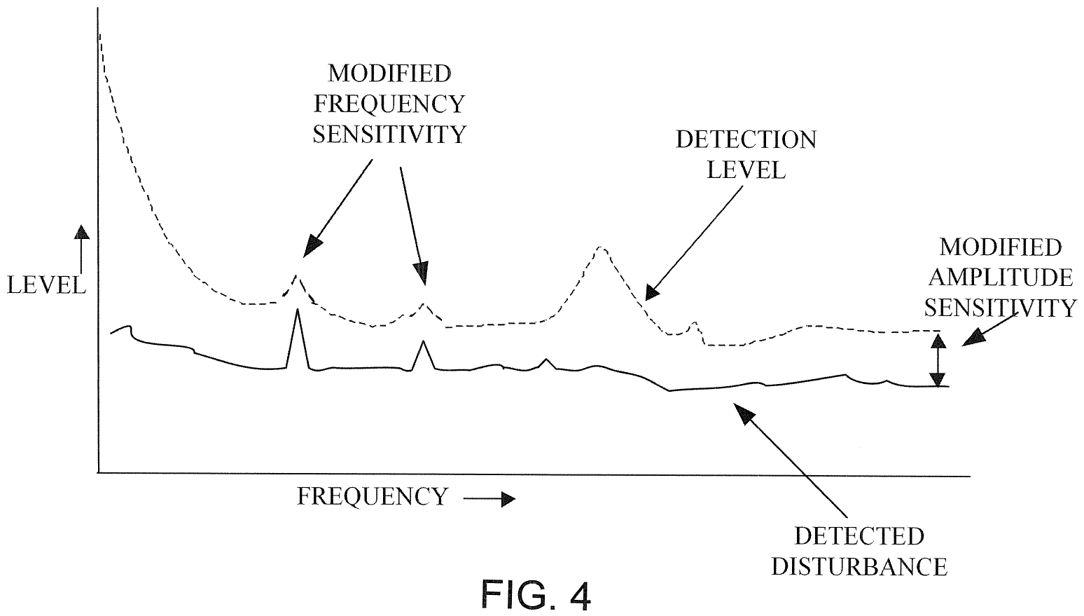

FIG. 5 shows schematically operation of the time-based algorithm where a delta is used to provide a threshold value to compare with new data in the incoming stream.

### DETAILED DESCRIPTION

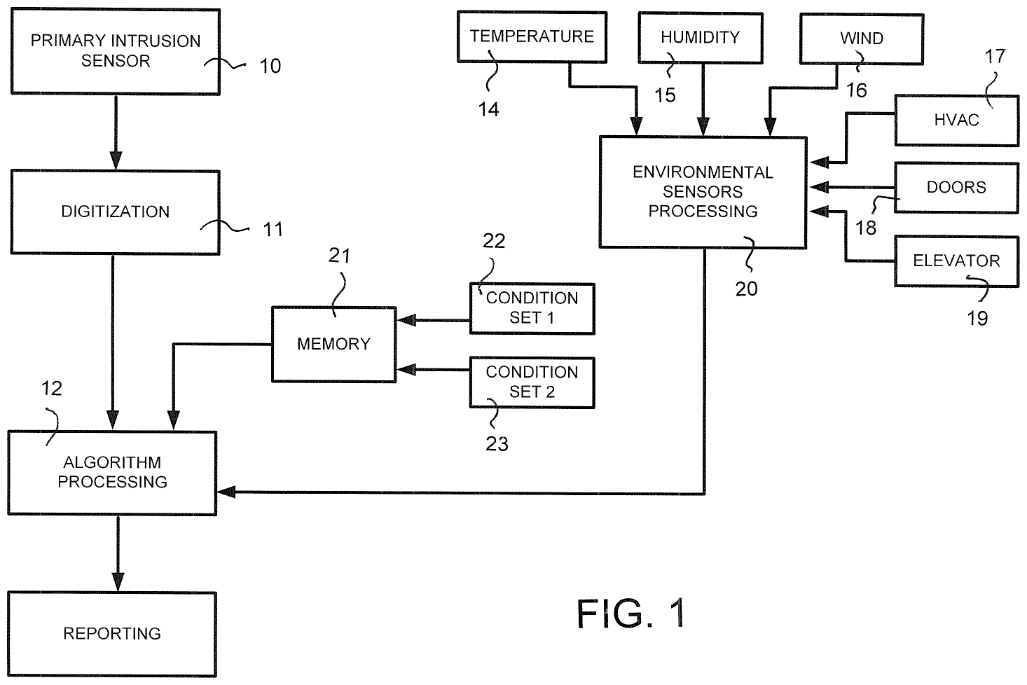

FIG. 1 is a schematic illustration of an intrusion detection system according to the present invention. This includes a monitoring intrusion sensor 10 which provides output data to an algorithm processing system which uses algorithms to analyze signals from a monitoring sensor, such as an optical fiber The signals are typically changed to digital format for the analysis at 11. The system after analysis provides an output report at 13. In accordance with the present invention, there is provided external sensors 14, 15, 16 for inputting data relating to environmental conditions thus allowing these to be used in the algorithm. Sensors monitor environmental conditions including ambient temperature, humidity, and wind. In addition input data is provided directly from spurious disturbances such as HVAC systems 17, door open/close 18, and elevator operation 19. The occurrence and magnitude of these events are input to the Algorithm Processing portion through an environmental sensor processing component 20. This input used in conjunction with conditions stored in memory are used to modify the response to digitized input from the primary sensor.

The algorithm processing component can receive data from a memory 21 which includes stored data from pre-set conditions 22 and 23. That is previous analysis of the environment can set up conditions 22 and 23 such as work day, non-working day which can be entered automatically from memory. In the event that a new time division is determined to require the same conditions, such as when a new shift is started on a different day or time of day, the same conditions calculated for other working shifts can be immediately entered into the analysis in the algorithm processing.

The arrangement in FIG. 1 uses either frequency domain, time domain, or a combination of both analysis algorithms as discussed hereinafter.

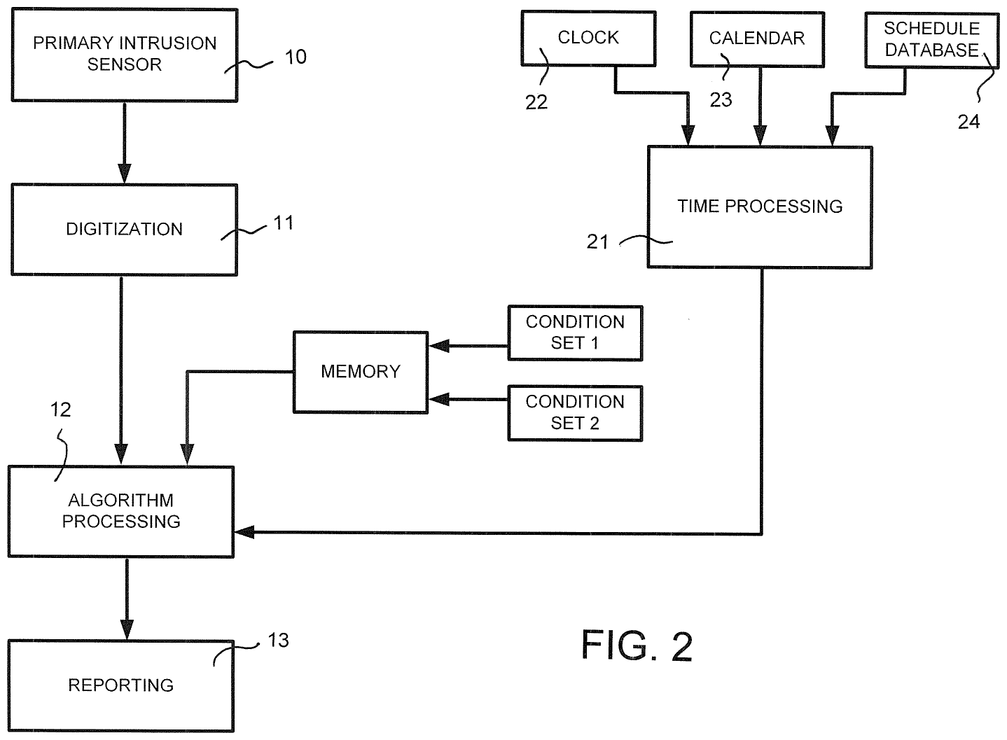

FIG. 2 is a schematic illustration of an intrusion detection system according to the present invention which uses either frequency domain, time domain, or a combination of both analysis algorithms as discussed hereinafter to analyze signals from a monitoring sensor, such as an optical fiber. In this arrangement the analysis—includes data relating to current time 22, as well as a calendar 23 of conditions thus allowing these to be used in the algorithms. The Time Processing portion processes input from mechanism reporting time of day (such as a clock), current day such as a calendar, as well as a data base 24 of scheduled events such as weekends and holidays. The occurrence and significance of these events are input to the Algorithm Processing portion 12. This input used in conjunction with conditions stored in memory are used to modify the response to digitized input from the primary sensor.

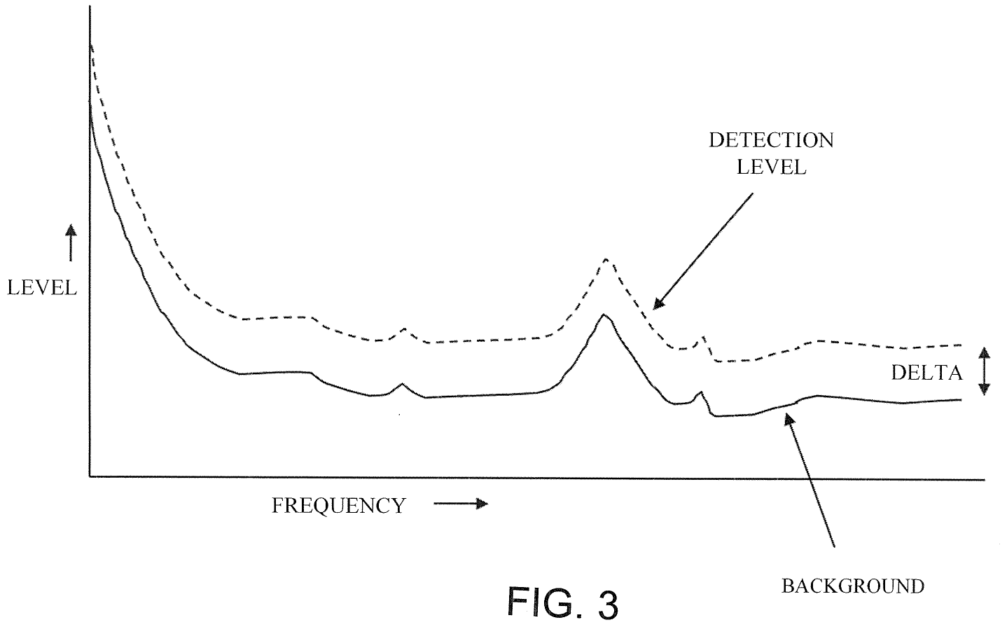

In FIG. 3 is shown a graph of the Frequency Envelope in which the method of the invention samples data from an A/D converter which is monitoring the signal to be analyzed. The sample stream is divided in to equal length pieces, and then transformed with a Fourier Transform (FT) algorithm. This creates a three-dimensional dataset consisting of frequency domain amplitude, frequency, and time. The Frequency Envelope shown in FIG. 1 is calculated by taking the maxima over the time dimension, leaving a two-dimensional frequency domain amplitude vs frequency dataset as shown. Additionally, a constant delta is additively or multiplicatively applied to each frequency amplitude element to adjust intrusion sensitivity. That is, the delta or difference value is either simply added to the envelope, to define the threshold value or detection level to be exceeded by the next amplitude element value calculated by the algorithm, or the delta or difference value can be applied by a multiplication factor applied to the value of the element. This algorithm provides a Smart Filter Detection (SFD) plot.

The line called “Background” is the “response curve” and the “FT reference plot” described in the paragraph above. In use, the “Background” is offset by the “delta” (a user configurable variable) to create the “Detection Level”. The ongoing frequency measurement is compared to this “Detection Level”, and when it crosses it an alarm is reported.

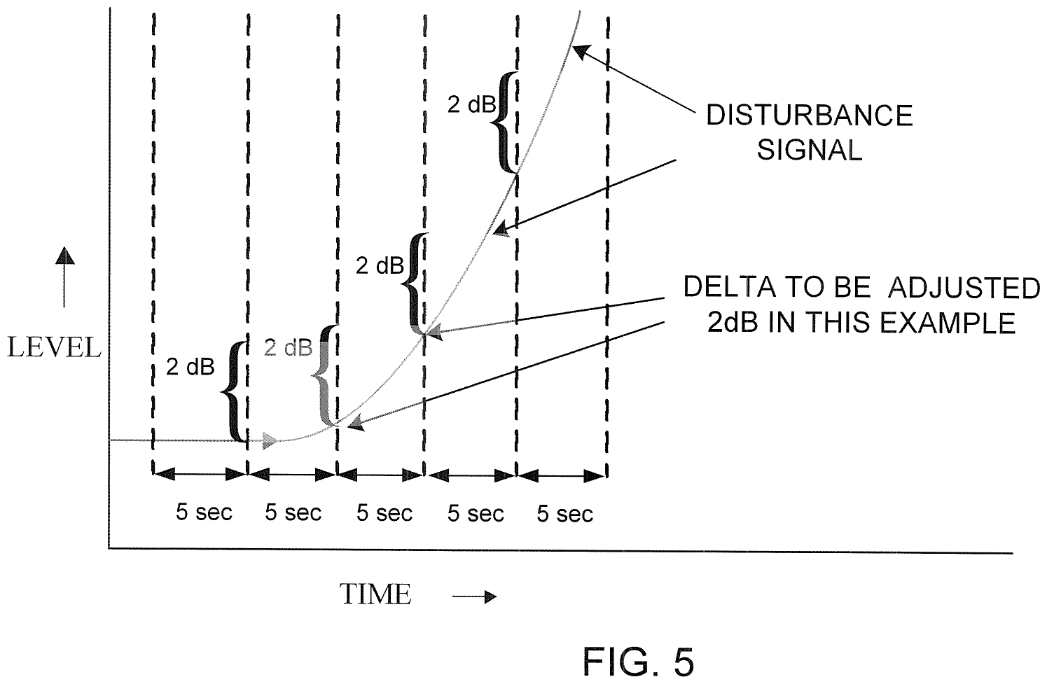

Additionally, as shown in FIG. 5, a time domain algorithm is provided called Intrusion Signature (IS) which watches changes in static level over time. It is calculated during autoconfiguration as well, but is not tied to the above Smart Filter Detection (SFD) plot. That is the two complement each other.

The arrangement herein thus has the following key features:

-a- Changing the Delta or sensitivity;

-b- Modifying the reference signal;

-c- Doing either of the above in the time domain algorithm.

The algorithm can be changed in different time periods in response to ambient conditions of the environment determined for those time periods by any one or more of the following:

-a- The Time of day—shifts—traffic, HVAC, elevators. As the system monitors the sensor, there are changes to the environment in which the monitor is installed. These changes might affect the ambient signature to a degree to which the ability to detect the desired signal is changed. A frequency monitoring system will detect a sudden, low frequency periodic signal when a freight elevator is operated. Additional sources of this shift might be the nearby road traffic at the end of a shift, footfalls caused by the personnel during busy hours, or the HVAC system turning blowers on and off as the temperature changes over the course of the day as caused by outdoor temperature, density of population, or heat generated by equipment.

-b- Time of week—weekends. Ambient changes can also be affected by the time of the week. For example, perhaps a large delivery truck pulls in every Tuesday c, causing a low frequency vibration. During weekend, the ambient might become quiet due to the lack of workers. The system would increase sensitivity to take advantage of that enhanced ability to detect signals.

-c- Time of year—seasonal changes. Seasonal changes cause changes in the ambient signature based on the HVAC system. Outdoor temperature rising in the springtime will cause the air conditioner to run intermittently. This will cause vibrations from the fans as well as air flow. This is true for furnaces in the winter and dehumidifiers in the summer, as examples.

-d- Calendar events—holidays. On holidays, businesses are often closed and the buildings empty of personnel. This situation affords two scenarios. First, the lack of personnel will quieten the environment, allowing the monitoring system to be operated at enhanced level of sensitivity. Additionally, an empty building will be a target for physical intruders. The above mentioned sensitivity enhances protection in this instance.

-e- Programmable events—after hours open house, for example. Programmable events such as after hours open houses bring both strangers into the environment and the need for lower sensitivity in the high-traffic areas as well as higher sensitivity in the off-limits areas.

-f- by monitoring outdoor temperature, humidity, and wind. Outdoor events can directly impact the ambient environment within a monitored space. Some examples include:

Change in temperature can cause HVAC systems to cycle, as mentioned above;

Humidity increase can cause the need for de-humidifiers to engage, potentially causing vibration and air flow. Additionally, the change in humidity can subtly change the frequency and absorptive characteristics of the air within a controlled space;

An increase in wind can impact the monitor system in several ways:

Wind will shake a fence in a perimeter monitor system;

Wind will shake vegetation—potentially affecting a perimeter monitor system or impacting a building that contains a monitored space

Wind can blow across open conduits, pipes, gutters, and windows, causing resonances such as “howling”, introducing a periodic signal that was not present during the autoconfiguration calibration.

The algorithm can be varied in accordance with one or more of the following:

-a- Sensitivity of detection algorithms as function of above timing considerations. Time domain algorithms, such as Intrusion Signature (IS) can be adjusted by altering the magnitude of the signal delta or the signal time window during which an event is captured. Frequency domain algorithms such as Smart Filter Detection (SFD) offer a variety of controls for adjusting sensitivity. These include:
-1- Adjust the delta between the reference frequency response amplitude and the measured signal. This raises or lower sensitivity across all frequencies.
-2- Detect specific frequencies that are alarming under changed ambient conditions, and decrease sensitivity at those specific frequency bands
-3- Evaluate the size of the specific alarm event, this might be in the form of a peak signal at a specific frequency, or the area under the curve of a signal as it crosses the reference. Determine if the signal is below a certain “nuisance” level, and delete the event rather than act upon it.

-b- Sensitivity of detection algorithms as function of magnitude of event. The detection algorithms benefit from the enhancements of this invention as maximum sensitivity must always balance against lack of false and nuisance alarms. Systems must be able to detect a stealthy attack while not constantly be sounding alarms from non-events.

-c- Sensitivity of detection algorithms as function of magnitude of ambient. Similarly, and referencing the need for maximum sensitivity, the system must detect a stealthy event while not reporting alarms from such things as a rise in ambient noise such as an elevator or air handler.

The method herein operates to autoconfigure over the long period of time, store incremental values and select the portions that correspond to the time window. This allows changes to time windows

The method can operate to perform a series of autoconfigurations during each specified time window. The down side of this method is that it does not allow later adjustment.

1. A method of analyzing a monitoring signal from a sensing system where the monitoring signal varies over time to determine an alarm condition, the method comprising:
the sensing system being located in an environment including ambient conditions and operating during a plurality of different time periods;
providing the monitoring signal as a stream of digital values;
analyzing the stream of digital values using a frequency-based or time-based algorithm to generate a plot of elements obtained from the analysis;
applying a delta additively or multiplicatively to each element of the plot of elements to adjust sensitivity thereof to provide a threshold;
comparing a plurality of the elements of the stream with the threshold and triggering the alarm condition in the event that the threshold is exceeded;
and changing the algorithm in different time periods in response to ambient conditions of the environment determined for those time periods.

2. The method according to claim 1 wherein the algorithm is changed by changing the delta.

3. The method according to claim 1 wherein the algorithm is changed by adjusting the delta between the reference frequency response amplitude and the measured signal so as to raises or lower sensitivity across all frequencies.

4. The method according to claim 1 including detecting specific frequencies that are alarming under changed ambient conditions, and decreasing sensitivity at those specific frequency bands.

5. The method according to claim 1 including evaluating the size of the specific alarm event, which might be in the form of a peak signal at a specific frequency, or the area under the curve of a signal as it crosses the reference so as to determine if the signal is below a certain “nuisance” level, and delete the event rather than act upon it.

6. The method according to claim 1 wherein the ambient conditions are determined based on a time of week.

7. The method according to claim 1 wherein the ambient conditions are determined based on seasonal changes.

8. The method according to claim 1 wherein the ambient conditions are determined based on Calendar events.

9. The method according to claim 1 wherein the ambient conditions are determined based on programmable events,

10. The method according to claim 1 wherein the ambient conditions are determined based on monitoring external conditions including one or more of outdoor temperature, humidity, and wind.

11. The method according to claim 1 wherein the ambient conditions are determined based on HVAC activity.

12. The method according to claim 1 wherein the algorithm is changed to as to change a sensitivity of the detection algorithm as function of the timing considerations.

13. The method according to claim 1 wherein the algorithm is changed to as to change a sensitivity of the detection algorithm as a function of magnitude of the event.

14. The method according to claim 1 wherein the algorithm is changed to as to change a sensitivity of the detection algorithm as a function of a magnitude of the ambient conditions.

15. The method according to claim 1 wherein the algorithm is changed over the long period of time so as to store incremental values, and select the portions that correspond to the time window which allows changes to time windows

16. The method according to claim 1 wherein a series of autoconfigurations is performed during each specified time window.

17. The method according to claim 1 wherein the algorithm is changed to as to change alarm sensitivity such as an ambient rejection threshold.

18. The method according to claim 1 wherein the frequency algorithm comprises: dividing the sample stream in to equal length pieces each containing a series of the values; using a microprocessor to apply a Fourier Transform (FT) algorithm to transform each piece of the stream into a three-dimensional dataset including frequency domain amplitude, frequency and time and calculating a Frequency Envelope by taking the maxima over the time dimension for a period of time, leaving a two-dimensional frequency domain amplitude vs frequency dataset.

19. The method according to claim 15 wherein the method further includes the steps of comparing a plurality of the elements of the stream with the threshold, determining the discrete frequency bands found above the threshold applying said delta additively or multiplicatively to individual frequency elements of the plot of elements to adjust sensitivity thereof to provide a threshold and triggering the alarm condition in the event that the threshold is exceeded.

20. The method according to claim 1 wherein the time-based algorithm comprises detection or calculation of the change of a monitored signal as a function of monitor time.

21. The method according to claim 1 wherein the signal is extracted from an optical fiber in response to the injection into the fiber of a signal from a source and wherein the alarm condition is detection of movement or vibration in the fiber indicative of an intrusion event.

22. The method according to claim 1 wherein equipment located in the environment may be provided with a system so as to communicate the status of the equipment directly to the sensing system without the necessity for an added sensor.

23. The method according to claim 1 wherein the sensing system is arranged to look for events which occur at certain situations such as at certain times which act to trigger a false alarm condition and to generate data related to those events and the conditions under which they occur.

24. A method of analyzing a monitoring signal from a sensing system where the monitoring signal varies over time to determine an alarm condition,
the sensing system being located in an environment including ambient conditions and operating during a plurality of different time periods;
the method comprising:
providing the monitoring signal as a stream of digital values;
analyzing the stream of digital values using a frequency-based or time-based algorithm to generate a plot of elements obtained from the analysis;
comparing a plurality of the elements of the stream with a reference signal and triggering the alarm condition in the event that a difference from the reference is exceeded;
and changing the reference signal in different time periods in response to ambient conditions of the environment determined for those time periods.

25. A method of analyzing a monitoring signal from a sensing system where the monitoring signal varies over time to determine an alarm condition,
the sensing system being located in an environment including ambient conditions and operating during a plurality of different time periods;
the method comprising:
providing the monitoring signal as a stream of digital values;
analyzing the stream of digital values using a time-based algorithm to generate a plot of elements obtained from the analysis;
applying a delta additively or multiplicatively to each element of the plot of elements to adjust sensitivity thereof to provide a threshold;
comparing a plurality of the elements of the stream with the threshold and triggering the alarm condition in the event that the threshold is exceeded;
and changing the time-based algorithm in different time periods in response to ambient conditions of the environment determined for those time periods.
